(19) United States
(12) Patent Application Publication
(10) Pub. No.: US 2007/0207836 A1
(43) Pub. Date: Sep. 6, 2007

(54) Wireless base station

(76) Inventors: Eamonn F. Gormley, Montreal (CA); Louis-Francois Sansfacon, Laval (CA); Radu Gheorghe Bota, Montreal (CA)

Correspondence Address: HOLLAND & KNIGHT LLP, 10 ST. JAMES AVENUE, 11th Floor, BOSTON, MA, 02116-3889, US

(21) Appl. No.: 11/369,208

(22) Filed: Mar. 6, 2006

(51) Int. Cl. H04B 7/00; H04B 1/38

(52) U.S. Cl. 455/561; 455/502

(57) ABSTRACT

A wireless base station system includes a phase-locked loop (PLL) and hold-over circuit linked to multiple frequency and time reference input connectors and a Global Positioning System (GPS) module having an antenna, and an output reference control circuit linked to the PLL and hold-over circuit and multiple frequency and time output connectors. The PLL and hold-over circuit can enable synchronization on either the GPS module or the multiple frequency and time references inputs. The output reference control circuit can generate frequency and timing reference signals for external equipment. The external equipment can include one or more wireless base stations.

### BACKGROUND

The present invention relates to wireless networks, and more particularly to a wireless base station.

A cellular network is a radio network made up of a number of radio cells (or just cells) each served by a fixed transmitter, known as a cell site or base station. These cells are used to cover different areas in order to provide radio coverage over a wider area than the area of one cell.

A Base Station Subsystem (BSS) is responsible for handling traffic between a remote fixed or mobile subscriber station and a Network Switching Subsystem (NSS). The BSS carries out modulation and demodulation of data over the wireless link, transcoding of speech channels, allocation of radio channels to mobile stations, paging and many other tasks related to the radio network. The BSS can also transmit and receive packet data over its radio network interface as part of a Broadband Wireless Access (BWA) network. The BSS typically includes a Base Station Transceiver Subsystem (BTS) and a Base Station Controller (BSC).

The BTS contains the equipment for transmitting and receiving of radio signals (transceivers), antennas, and equipment for encrypting and decrypting communication with the BSC. Typically a BTS has several different transceivers (TRXs) that allow it to serve several different frequencies and different sectors of the cell.

The BSC provides the intelligence behind the BTSs. The BSC handles allocation of radio channels, receives measurements from the mobile stations, and controls handovers from BTS to BTS.

### SUMMARY

The present invention provides methods and apparatus for a wireless base station.

In one aspect, the invention features a wireless base station system including a phase-locked loop (PLL) and hold-over circuit linked to multiple frequency and time reference input connectors and a Global Positioning System (GPS) module having an antenna, and an output reference control circuit linked to the PLL and hold-over circuit and multiple frequency and time output connectors.

In embodiments, the PLL and hold-over circuit can enable synchronization on either the GPS module or the multiple frequency and time references inputs. The PLL and hold over circuit can enable synchronization on the GPS module and the multiple frequency and time reference inputs, the GPS module assigned a first priority and the multiple frequency and time reference inputs assigned a second priority.

The output reference control circuit can generate frequency and timing reference signals for external equipment. The external equipment can include one or more wireless base stations.

The multiple frequency and time reference input connectors can be RJ-45 connectors. The multiple frequency and time reference output connectors can be RJ-45 connectors.

The wireless base station system can include a connection to the Internet to can enable high speed Internet data to a subscriber station.

In another aspect, the invention features a wireless network including a master base station daisy-chained to one or more secondary base stations, the master base station and one or more secondary base stations each including a phase-locked loop (PLL) and hold-over circuit linked to multiple frequency and time reference input connectors and a Global Positioning System (GPS) module having an antenna, and an output reference control circuit linked to the PLL and hold-over circuit and multiple frequency and time output connectors.

In embodiments, the PLL and hold-over circuit can enable synchronization on either the GPS module or the multiple frequency and time reference inputs. The output reference control circuit of the master base station can generate frequency and timing reference signals for a second base station. The output reference control circuit of the second base station can generate frequency and timing reference signals for a third base station.

In another aspect, the invention features a wireless network including a master base station linked to, and controlling point-to-multipoint synchronization of, one or more secondary base stations, the master base station and one or more secondary base stations each including a phase-locked loop (PLL) and hold-over circuit linked to multiple frequency and time reference input connectors and a Global Positioning System (GPS) module having an antenna, and an output reference control circuit linked to the PLL and hold-over circuit and multiple frequency and time output connectors.

In embodiments, the PLL and hold-over circuit can enable synchronization on either the GPS module or the multiple frequency and time references inputs. The PLL and hold-over circuit can enable synchronization on the GPS module and the multiple frequency and time reference inputs, the GPS module assigned a first priority and the multiple frequency and time reference inputs assigned a second priority.

The output reference control circuit of the master base station can generate frequency and timing reference signals for the one or more secondary base stations.

In another aspect, the invention features a method of synchronizing base stations in a wireless network including generating frequency and timing reference signals from a master base station to synchronize one or more secondary base stations linked to the master base station.

In embodiments, the master base station and one or more secondary bases stations can include a phase-locked loop (PLL) and hold-over circuit linked to multiple frequency and time reference input connectors and a Global Positioning System (GPS) module having an antenna, and an output reference control circuit linked to the PLL and hold-over circuit and multiple frequency and time output connectors.

The PLL and hold-over circuit can enable synchronization on either the GPS module or the multiple frequency and time reference inputs.

The master base station and one or more secondary bases stations can include a connection to the Internet to can enable high speed Internet data to a subscriber station.

The invention can be implemented to realize one or more of the following advantages.

A base station includes an external frequency reference input, an external time reference input, an external time reference output, an external frequency reference output and optional Global Positioning System (GPS) antenna input. With these connectors, multiple base stations can be locked together in both frequency and time. For example, one of the base stations can be locked to GPS, while the other base stations are locked to the first base station using the external frequency and time reference inputs and outputs.

A base station enables either an external GPS receiver, or a GPS receiver built into a first base station, to provide time and frequency references to multiple base stations. Only one GPS antenna connection is required. Additionally, if the time or frequency reference is removed, the base stations go into a holdover mode, where they attempt to maintain the most recent frequency and time references in the absence of the master reference.

A base station architecture including time and frequency reference inputs and outputs ensures that even if the master reference is removed, the base stations that are connected together maintain their time and frequency relationship.

A base station that includes time and frequency reference inputs and outputs can reduce the cost of base station equipment (e.g., GPS receiver can be left out of base stations).

A base station design that includes time and frequency reference inputs and outputs can reduce the cost of installation (e.g., single GPS antenna and cable required).

Base stations remain locked together in time and frequency when a master time and frequency source is removed.

One implementation of the invention provides all of the above advantages.

Other features and advantages of the invention are apparent from the following description, and from the claims.

### BRIEF DESCRIPTION OF THE DRAWINGS

FIG. 1 is a block diagram of an exemplary wireless network.

FIG. 2 is a block diagram of an exemplary synchronization scheme for base station equipment.

FIG. 3 is a block diagram of an exemplary implementation.

FIG. 4 is a block diagram of an exemplary implementation.

FIG. 5 is a block diagram of an exemplary implementation.

FIG. 6 is a block diagram of an exemplary implementation.

FIG. 7 is a block diagram of an exemplary implementation.

Like reference numbers and designations in the various drawings indicate like elements.

### DETAILED DESCRIPTION

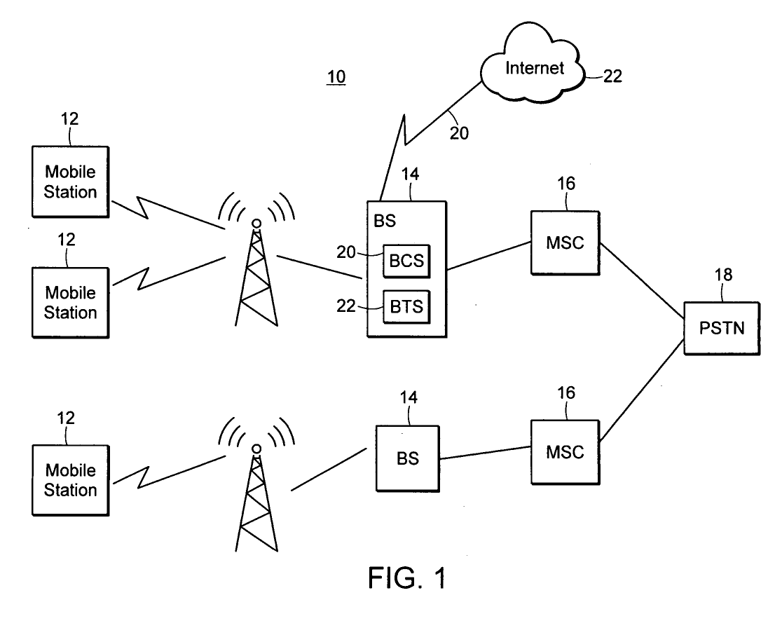

As shown in FIG. 1, an exemplary wireless network 10 is hierarchical structure and includes mobiles stations 12, one of more base stations (BS) 14 and one or more mobile switching centers (MSCs) 16. The wireless network 10 enables wireless (also referred to as cellular) subscribers to wander anywhere and remain connected to each other and to a Public Switched Telephone Network (PSTN) 18. Typically, BSs are connected to a MSC using land lines. Each MSC is connected to a PSTN main switching center.

Each MSC 16 performs telephony switching functions. The MSC 16 controls calls to and from other telephone and data systems. The MSC 16 can perform functions such as toll ticketing, network interfacing, common channel signaling, and so forth.

Each BS 14 performs most radio-related functions and typically includes a base station controller (BSC) 20 and a base transceiver station (BTS) 22. The BSC 20 provides all the control functions and physical links between the MSC 16 and BTS 22. The BSC 20 is a high-capacity switch that provides functions such as handover, cell configuration data, and control of radio frequency (RF) power levels in BTSs. In a typical configuration a group of BSCs are served by the MSC 16.

The BTS 22 handles the radio interface to the mobile stations 12. The BTS 22 is the radio equipment (i.e., transceivers and antennas) needed to service each cell in the wireless network 10. A group of BTSs is controlled by a BSC 20.

The BS 14 can include a connection 20 to the Internet 22 to enable high speed Internet data to a subscriber station 12.

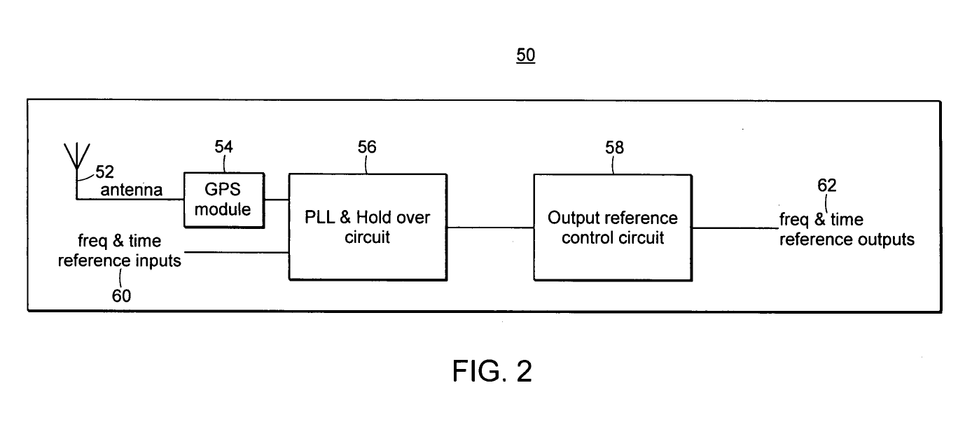

As shown in FIG. 2, an exemplary synchronization scheme 50 for base station equipment includes an antenna 52, a Global Positioning System (GPS) module 54, a phase-locked loop (PLL) and hold-over circuit 56 and an output reference control circuit 58. The scheme 50 includes frequency and time reference inputs 60 and frequency and time reference outputs 62.

The PLL and hold-over circuit 56 enables synchronization on either of the reference inputs, i.e., the GPS module 54 or frequency and time references inputs 60. Outputs of the PLL and hold-over circuit 56 are sent to the output reference control circuit 58, which generates frequency and timing reference for external equipment. External equipment can include one or more base stations, which may or may not include antennae. In the event of a loss of the reference input, the PLL and hold-over circuit 56 goes into an hold-over mode, enabling a master BS to remain locked to an equivalent frequency and phase of a last stable moment of the input reference. A transition to hold-over mode is transparent to the output reference control circuit 58, allowing it to keep its frequency and time reference outputs stable. Losses of reference only affect the first equipment (i.e., master BS); the following equipment connected to reference output connector remains stable and fully synchronized with the master BS. Using separate input and output connectors enable easy daisy chaining to a BS. Disconnecting one BS has no functionality impact on a co-located BS as it would be by using multiple GPS antennae.

The scheme 50 includes, in addition to a frequency reference, a time reference. A time reference is advantageous for several different types of base stations, such as, for example, base stations for wireless systems that use Code-Division Multiple Access (CDMA) and base stations for wireless systems that use Time Division Duplexing (TDD). Traditionally, a timing reference is derived from a GPS receiver. Here, scheme 50 only needs one connection to a GPS antenna when there are multiple base stations located at the same site.

If an external timing reference is not available (e.g. from GPS), scheme 50 still generates its own internal timing reference. This timing reference is available on the timing output connector. Thus, multiple base stations that incorporated scheme 50 at the same location, can be locked in time to a master base station, even if the master base station does not have an external time reference.

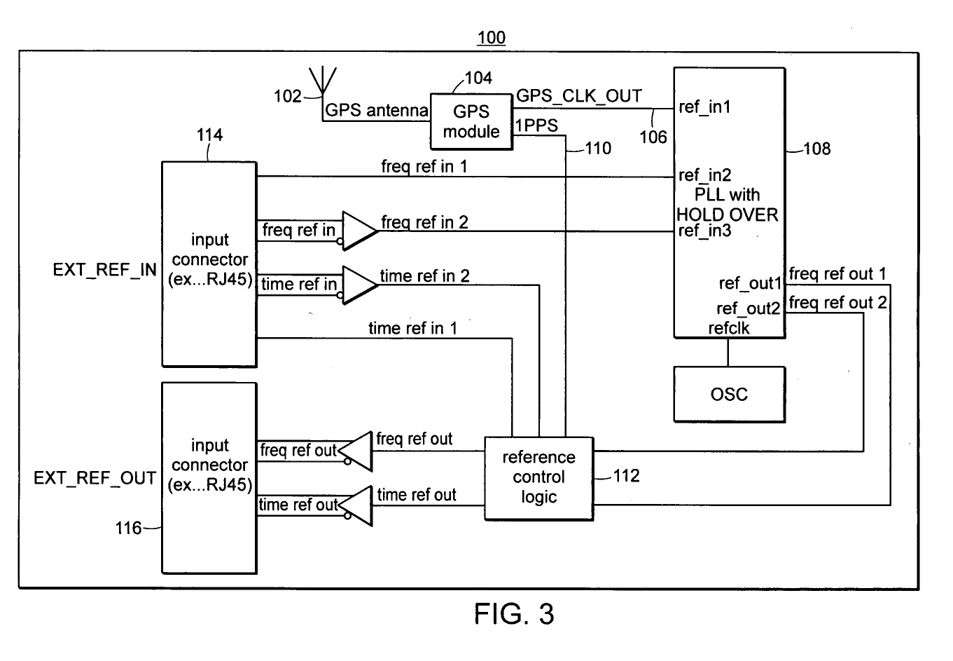

As shown in FIG. 3, an exemplary implementation 100 of the synchronization scheme 50 can be implemented in a CBS5000 WiMax Base Station made by SR Telecom Inc., Montreal, Quebec, Canada. The implementation 100 includes a GPS antenna 102 linked to a GPS module 104. The GPS module 104 generates two signal outputs, i.e., a GPS CLK OUT signal 106 to a PLL and hold-over circuit 108, and an accurate timing reference signal of one pulse per second (PPS) signal 110, for example, to an output reference control circuit 112.

The implementation 100 includes frequency and time reference inputs 114 and frequency and time reference outputs 116. In this particular implementation 100, the inputs 114 and outputs 116 are RJ-45 connectors, which enable easy daisy chaining of the implementation 100 using Ethernet cable.

The implementation 100 can link to subscriber stations. Subscriber stations can be fixed or mobile, and can serve a single customer, or can provide service to multiple customers, each of which has a connection to the subscriber station.

The implementation 100 is not under control of a MSC. The implementation 100 can also have a connection to the Internet to enable providing high speed Internet data to a subscriber station.

The implementation 100 can transmit and receive packet data as part of a Broadband Wireless Access (BWA) network, as well as carry voice signals to and from a subscriber station and the PSTN.

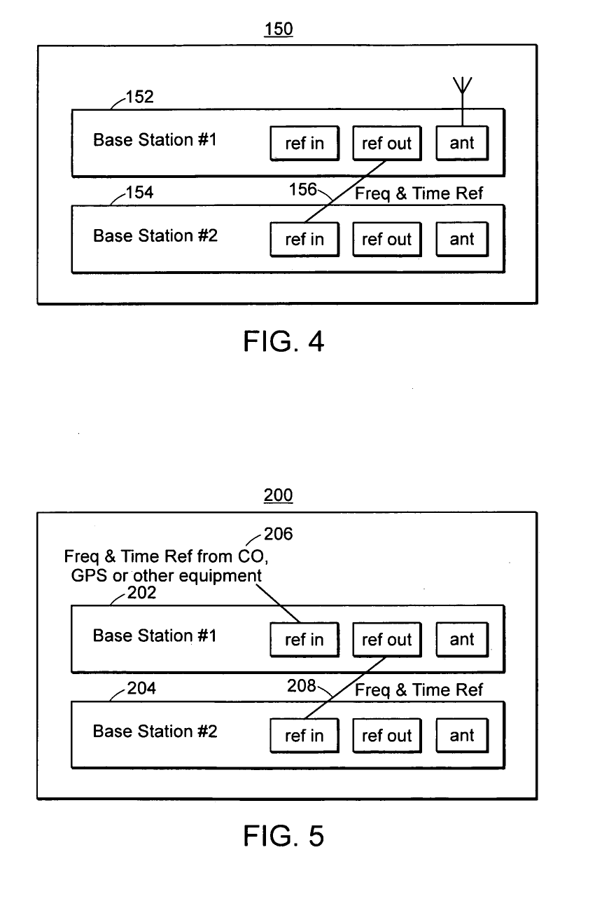

Using the synchronization scheme 50 for base station equipment enables many connection configurations of multiple base stations. For example, as shown in FIG. 4, a first exemplary connection scheme 150 includes a master BS 152 and a second BS 154. The master BS 152 is synchronized in time and frequency by a signal from its GPS module. The second BS 154 is synchronized on a frequency and time reference output signal 156 of the master BS 152.

As shown in FIG. 5, a second exemplary connection scheme 200 includes a master BS 202 and a second BS 204. In this scheme 200, an external reference 206, which can come from a Central Office (CO), external GPS receiver, or other equipment, synchronizes the master BS 202. The second BS 204 is synchronized on a frequency and time reference output signal 208 of the master BS 202.

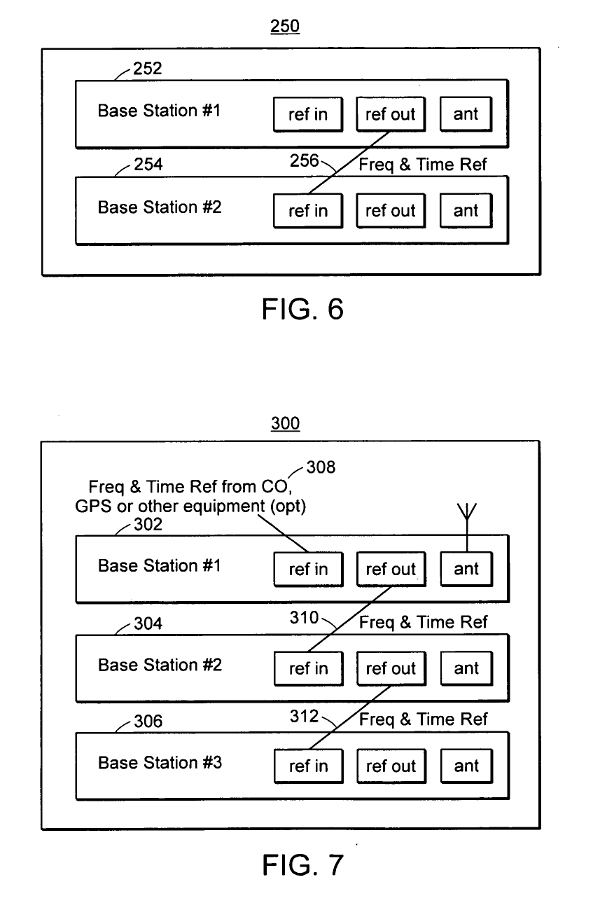

As shown in FIG. 6, a third exemplary connection scheme 250 includes a master BS 252 and a second BS 254. In the connection scheme 250, if the master BS 252 loses its frequency and time reference input the master BS 252 enters a hold-over mode. The second BS 254 remains synchronized on a frequency and time reference output signal 256 from the master BS 252. If desired, the master BS 252 can be in a free-run mode.

As shown in FIG. 7, a fourth exemplary scheme 300 includes a master BS 302, a second BS 304 and a third BS 306. In this particular scheme 300, synchronization can be provided to the master BS 302 using its GPS module or an external reference 308. Here, the second BS 304 is synchronized on a frequency and time reference output signal 310 of the master BS 302. The third BS 206 is synchronized on a frequency and time reference output signal 312 of the second BS 304. In one specific example, the second BS 304 and the third BS 306 do not include antennae.

In another example, GPS antenna and external synchronization can be used simultaneously if their synchronization priority is set, which adds the possibility of having another reference source. For example, losing a GPS signal forces the PLL & hold-over circuit to synchronize on the external reference from the CO. If this reference is also lost or inadequate then hold-over mode is enabled. This can be useful if an extremely high accuracy external frequency reference is available but a high accuracy external time reference is not available. In this case, the master base station is locked in both frequency and time to the GPS reference. If the GPS reference is disconnected, the master base station uses the external frequency reference. In the absence of an external time reference, the master base station derives a timing signal from the frequency reference. Since the timing signal was originally locked to the GPS reference, it will not effectively be locked to the external high accuracy frequency reference.

Although specific examples above have been described, the number of interconnected bases stations is not limited to three. The above described examples use a daisy chain (i.e., point-to-point) interconnection approach. In other examples, a point-to-multipoint deployment can be used. In a point-to-multipoint deployment, secondary base stations are each synchronized directly by a frequency and time reference output signal from a master base station. A point-to-multipoint deployment can exhibit issues with respect to signal integrity (e.g., signal attenuation, reflection causing double clocking, and so forth), and may require special cabling.

It is to be understood that the foregoing description is intended to illustrate and not to limit the scope of the invention, which is defined by the scope of the appended claims. Other embodiments are within the scope of the following claims.

What is claimed is:

1. A wireless base station system comprising:
a phase-locked loop (PLL) and hold-over circuit linked to multiple frequency and time reference input connectors and a Global Positioning System (GPS) module having an antenna; and
an output reference control circuit linked to the PLL and hold-over circuit and multiple frequency and time output connectors.

2. The wireless base station system of claim 1 wherein the PLL and hold-over circuit enables synchronization on either the GPS module or the multiple frequency and time references inputs.

3. The wireless base station system of claim 1 wherein the PLL and hold over circuit enables synchronization on the GPS module and the multiple frequency and time reference inputs, the GPS module assigned a first priority and the multiple frequency and time reference inputs assigned a second priority.

4. The wireless base station system of claim 1 wherein the output reference control circuit generates frequency and timing reference signals for external equipment.

5. The wireless base station of claims 3 wherein the external equipment comprises one or more wireless base stations.

6. The wireless base station system of claim 1 wherein the multiple frequency and time reference input connectors are RJ-45 connectors.

7. The wireless base station system of claim 1 wherein the multiple frequency and time reference output connectors are RJ-45 connectors.

8. The wireless base station system of claim 1 further comprising a connection to the Internet to enable high speed Internet data to a subscriber station.

9. A wireless network comprising:
a master base station daisy-chained to one or more secondary base stations, the master base station and one or more secondary base stations each comprising:
a phase-locked loop (PLL) and hold-over circuit linked to multiple frequency and time reference input connectors and a Global Positioning System (GPS) module having an antenna; and
an output reference control circuit linked to the PLL and hold-over circuit and multiple frequency and time output connectors.

10. The network of claim 9 wherein the PLL and hold-over circuit enables synchronization on either the GPS module or the multiple frequency and time reference inputs.

11. The network of claim 9 wherein the output reference control circuit of the master base station generates frequency and timing reference signals for a second base station.

12. The network of claim 11 wherein the output reference control circuit of the second base station generates frequency and timing reference signals for a third base station.

13. A wireless network comprising:
a master base station linked to, and controlling point-to-multipoint synchronization of, one or more secondary base stations, the master base station and one or more secondary base stations each comprising:
a phase-locked loop (PLL) and hold-over circuit linked to multiple frequency and time reference input connectors and a Global Positioning System (GPS) module having an antenna; and
an output reference control circuit linked to the PLL and hold-over circuit and multiple frequency and time output connectors.

14. The network of claim 13 wherein the PLL and hold-over circuit enables synchronization on either the GPS module or the multiple frequency and time references inputs.

15. The network of claim 12 wherein the PLL and hold-over circuit enables synchronization on the GPS module and the multiple frequency and time reference inputs, the GPS module assigned a first priority and the multiple frequency and time reference inputs assigned a second priority.

16. The network of claim 13 wherein the output reference control circuit of the master base station generates frequency and timing reference signals for the one or more secondary base stations.

17. A method of synchronizing base stations in a wireless network comprising:
generating frequency and timing reference signals from a master base station to synchronize one or more secondary base stations linked to the master base station.

18. The method of claim 16 wherein the master base station and one or more secondary bases stations comprise:
a phase-locked loop (PLL) and hold-over circuit linked to multiple frequency and time reference input connectors and a Global Positioning System (GPS) module having an antenna; and
an output reference control circuit linked to the PLL and hold-over circuit and multiple frequency and time output connectors.

19. The method of claim 17 wherein the PLL and hold-over circuit enables synchronization on either the GPS module or the multiple frequency and time reference inputs.

20. The method of claim 16 wherein the master base station and one or more secondary bases stations further comprise a connection to the Internet to enable high speed Internet data to a subscriber station.
